(19) United States
(12) Patent Application Publication
(10) Pub. No.: US 2005/0242315 A1
(43) Pub. Date: Nov. 3, 2005

(54) Rapid coupling device and method for assembling a coupling socket

(76) Inventor: Niels Kristian Lund, HEDENSTED (DK)

Correspondence Address: James C Wray, 1493 Chain Bridge Road, Suite 300, McLean, VA, 22101, US

(21) Appl. No.: 10/522,326

(22) PCT Filed: Jul. 14, 2003
(86) PCT No.: PCT/DK03/00496

§ 371 Date: Feb. 25, 2005

(30) Foreign Application Priority Data
Jul. 27, 2002 (DK) PA 2002 001149

(51) Int. Cl. F16K 51/00

(52) U.S. Cl. 251/149.6

(57) ABSTRACT

The invention relates to a rapid coupling device in particular for use in fluid lines, especially compressed air lines and water lines, wherein the coupling comprises a plug-in and a receiving socket made from one single piece. Furthermore, a socket device and a method for assembling such a rapid coupling socket device is described.

The present invention relates to a rapid coupling device in particular for use in fluid lines, especially compressed air lines and water lines, wherein the coupling comprises a plug-in and a receiving socket. Furthermore, a socket device and a method for assembling such a rapid coupling socket device is described.

Rapid coupling devices are used in a wide variety of applications. On factory floors and workshops compressed air is used as a source of energy for a number of devices, among others for polishing, drilling, binding, cleaning etc. The source of compressed air is usually a compressor where a hose leads the compressed air from the compressor to the tool which is to be used. With compressed airlines shall within the scope of this invention be understood any means of conveying compressed air form the source to the place/means of use.

High pressure and even low pressure water lines are increasingly gaining market shares as the number of tools and applications for water driven tools increase. Furthermore, the device according to the invention also finds use for normal water pressure applications, such as connecting garden hoses and the like.

In order to achieve a degree of flexibility in the use of tools and different hoses which can be used, rapid coupling devices have been developed whereby quick, easy and safe connections can be made between the compressor, the hose and the tool. The coupling device comprises two parts; a female socket device and a male plug-in device.

The present invention is concerned with the coupling device and especially with the female socket device.

In the art there are numerous coupling devices comprising a socket and a plug-in as described above. All these devices, and especially in this connection the socket devices, are made up from assembling a large number of components into one compact socket device.

The present invention is concerned with improving the prior art devices by minimising the number of parts necessary in order to achieve a safe, secure and airtight coupling. Furthermore, the invention provides a coupling with improved air tightness as well as fewer parts to be mounted.

This means that the cost both of manufacturing the parts and of assembling all the parts is considerably lessened. Furthermore, the possibility of erroneous assembly of the many parts is lessened due to the limited number of parts comprised in the present invention.

Accordingly, the invention provides a rapid coupling device which is particular in that the coupling socket body is made from one single piece.

When the socket body is made from a single part and not as prior art devices of two or more parts a correct and airtight structure is first of all provided.

In the art when having to assemble two or more parts this is usually done by screwing together the parts having corresponding threads. The different sections of the socket body are screwed together with a locking and/or tightening material between the threads.

When providing the socket as a single piece, no faults in the socket will occur due to wrongful assembly, for example by screwing sections of the socket body together which are not in complete alignment.

Furthermore, the locking and/or tightening material usually applied between the corresponding threads of two body sections is completely avoided. Usually, this material has a limited life expectancy and will deteriorate due to the exposure to sun light, oil or other materials present in the compressed air. The service life is therefore limited and after a while the sections of the socket will become loose with a corresponding loss of air pressure.

In a further advantageous embodiment of the rapid coupling, the coupling socket is adapted to receive a coupling plug-in and the socket comprises a coupling socket body, a valve located inside the coupling socket body, a valve spring urging the valve into a closed position when not coupled to a coupling plug-in, a gasket or seal between the valve and a valve seat arranged in the coupling socket body and locking means arranged in the socket for locking a coupling plug-in into secure coupling with the socket, a locking release means arranged slidingly on the outside of the socket body and influenced by a spring into a locking position.

This arrangement represents a simplified construction of the interaction between the locking release means and the valve arrangement inside the socket.

The valve assures that there only is a through going connection through the socket when a plug-in is installed and locked inside the socket body. When the plug-in is released and removed from the socket, the valve is moved into a closed position by the action of the valve spring.

In a further advantageous embodiment the valves travel in an interior cylindrical sliding surface provided in an interior wall of the socket body of less than 10 mm. Due to the construction of the valve body a very limited travel distance of the valve is necessary to respectively open or close the flow of compressed air through the socket body.

A very important feature for couplings of this type is the pressure needed to overcome the air pressure when forcing the plug-in device into the coupling socket. The lower the pressure the easier it is for the user to insert the plug-in into the socket. By the construction according to the invention the coupling pressure is kept very low which makes the coupling according to the invention easy and comfortable to use.

In order to maintain the valve in its position in the cylindrical sliding surface arranged in an interior wall of the socket body, an O-ring is arranged as a barrier for the valve. As the socket body is a one-piece construction it is necessary to arrange all the items inside the socket body through either the exit or the entry opening of the socket body.

In an alternative embodiment according to the invention the valve is made from a resilient material and has three or more legs arranged extending in the socket's longitudinal direction at one end, said legs having an outer diameter larger than the corresponding interior diameter of the socket body.

When arranging this valve member inside the socket body the valve will, due to the resiliency of the material and the legs arranged on the valve, deform slightly during installation. Once the valve is in the correct position, which is when the valve is fitted inside the interior cylindrical sliding surface provided in the interior wall of the socket body, the valve expands again and is kept in place by the slightly larger diameter of the legs when these come into contact with a ridge arranged at one end of the cylindrical sliding surface.

In this position the legs will fit inside the valve spring, which will stabilize and guide the movement of the valve.

In an alternative preferred embodiment of the valve member the exterior diameter of the valve is slightly less than the interior diameter of the valve socket body. The valve will in this configuration be maintained in its position by an O-ring.

In order to further guide and stabilize the valve's travel in the socket, the valve member may be provided with additional legs protruding opposite the first set of legs. These legs will be guided by the interior edge of the O-ring locking the valve in position in the socket.

In a further advantageous embodiment a ring member may be arranged at either or both sets of legs, the free ends connecting all leg members. By this arrangement the valve member becomes less fragile, especially during manufacture and assembly of the socket device.

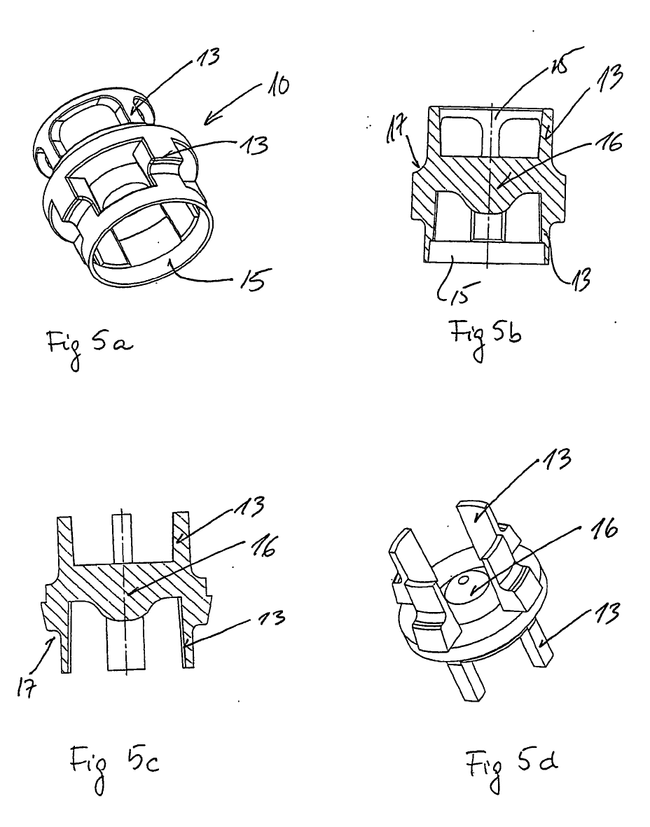

In FIG. 4 the coupling device in its coupled and opened position is illustrated. The male connector 14 is completely inserted into the female receiving socket 6 such that the front part of the male connector 14 forces the valve from its seat 12, whereby a fluid medium will be able to pass the valve 10. The route of the fluid through the coupling device is illustrated by the broken line 15.

The male connector 14 is locked in the engaged position by the locking balls 7.

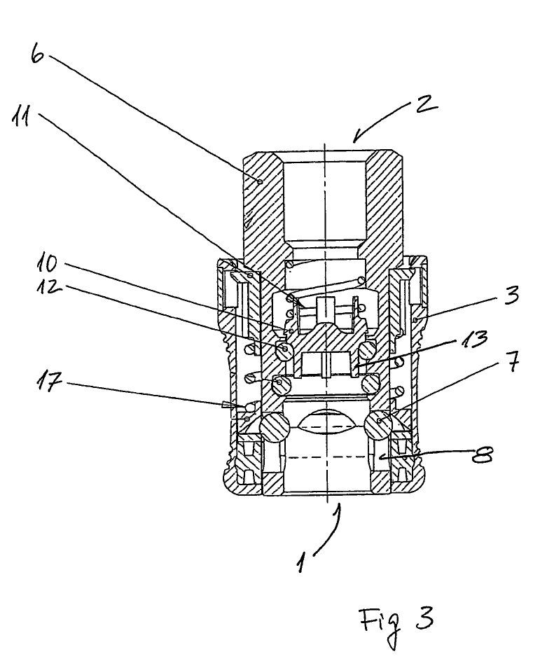

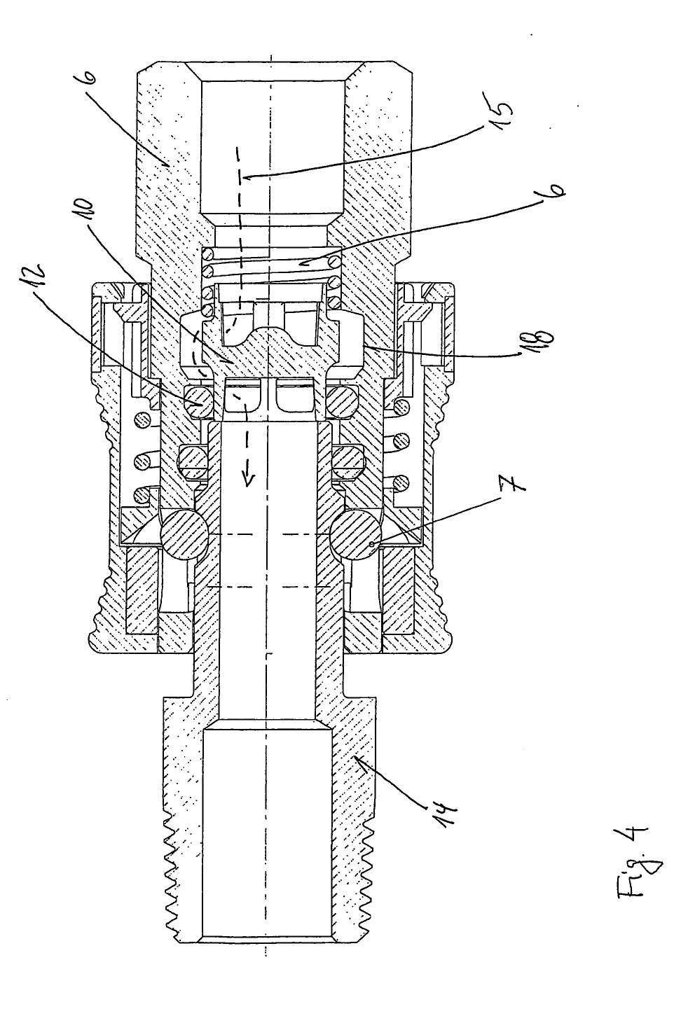

The valve element 10 can have any suitable configuration. In FIG. 5a-d two examples of valve elements 10 are illustrated. In FIG. 5a a perspective view of a first valve element 10 is illustrated and the corresponding cross-section is illustrated in FIG. 5b. The valve 10 comprises a main valve body 16 in which a valve seat 17 is provided. The valve seat 17 is adapted to engage the gasket/seal 12 in the socket device. The legs 13 extending from the main body of the valve are provided in order to guide and stabilize the movement of the valve in the socket. The legs 13 will be guided by the valve spring 11 as illustrated in FIG. 3 or the interior side of the gasket/seal 12. In order to stabilize the construction, the valve 10 has, in this example as illustrated in FIG. 5a and 5b, been provided with a ring member 15 connecting the free extremities of the legs 13. The ring member creates a more stabile and stronger construction, especially during the assembly of a coupling device this is advantageous.

In FIG. 5c and 5d another alternative configuration of the valve 10 is illustrated. Like parts are denominated with like reference numbers.

The invention also comprises a coupling socket for use in compressed air lines. This coupling socket is particular in that the socket comprises locking means for retaining a plug-in device, valve means, connection means to a means for conveying compressed air, wherein the socket body is a single piece.

Also, a method for assembling a rapid coupling socket device is disclosed, being particular in that all parts of the coupling socket are mounted through the coupling opening in the socket body.

In a further step the method of assembly is as follows:

First, the valve spring is inserted, then the valve is inserted and fitted inside an inner cylindrical sliding surface provided in an interior wall of the socket body and fitted partly inside the valve spring. A first O-ring is arranged in an inner gasket groove, a second O-ring is arranged in an outer gasket groove, a ventilating ring is arranged about the outside of the socket body and a locking spring is arranged about an outside surface of the socket body and in contact with the ventilating ring. A ball ring for retaining locking balls is arranged in contact with a locking spring together with at least two locking balls and optionally two locking pins. A ball lock ring and an outer ring encapsulating all items arranged on the outside of the socket body is finally fitted.

In this manner it is possible to assemble the entire socket device through the entry opening of the socket body device.

As described above the first O-ring arranged in the inner gasket groove serves to retain the valve inside its inner cylindrical sliding surface provided in an interior wall of the socket body.

The second O-ring is arranged in order to seal the connection between the plug-in, when the plug-in is inserted into the socket body device. The locking balls as well as the locking pins are arranged in a traditional manner, the only inventive concept relating to the locking arrangement being that due to the fact that the socket body is a one-piece construction, the balls and pins are arranged after the valve arrangement is installed.

The invention will now be explained with reference to the accompanying drawing wherein

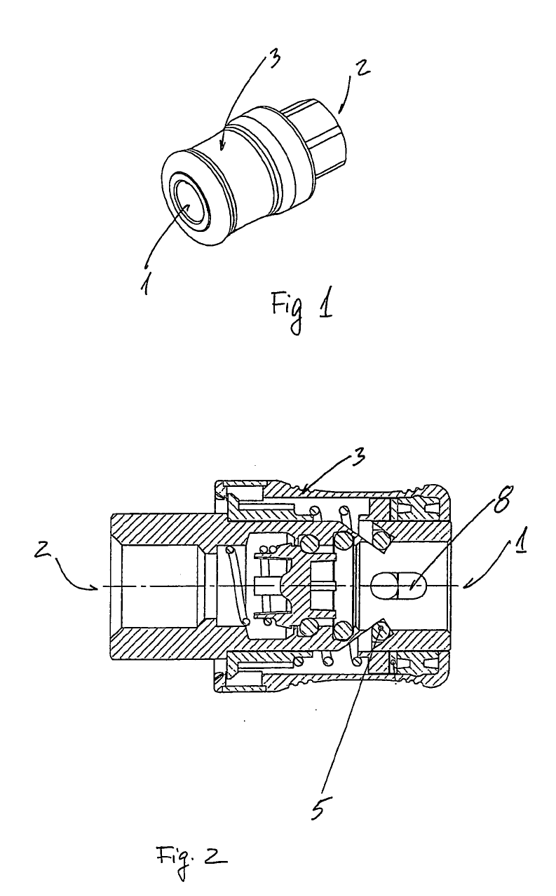

FIG. 1 illustrates a rapid coupling socket according to the invention;

FIG. 2 is a cross-sectional view of the coupling according to the invention;

FIG. 3 is a cross-section perpendicular to the cross-section of FIG. 2;

FIG. 4 illustrates a complete coupling in its open configuration;

FIG. 5a-d illustrate different embodiments of the valve body.

A rapid coupling socket according to the invention is illustrated in FIG. 1. The front opening 1 is of standardized size and suitable for receiving and locking a standard plug-in. The rear end 2 of the socket device is suitable for being connected to a compressed air hose or the like.

The locking ring 3 is the main exterior part of the rapid coupling device and is adapted to be manipulated by the user.

By pushing the locking ring 3 backwards, i.e. towards the rear end of the socket device, the locking axles 5 (see FIG. 2) as well as the locking balls (see FIG. 3) will be released whereby it is possible to remove a plug-in coupling device. When inserting a plug-in device into the socket in the front end, the locking pins as well as the locking balls will yield due to the resiliency of the locking ring spring 17.

The construction of the locking arrangement in the socket device for engaging a plug-in device is well known in the art and has more or less become a standard so that different tools with different plug-in devices or different sockets can interact.

Turning now to FIG. 3 a construction of a socket device according to the invention will be explained. In the front end 1 of the coupling socket the plug-in coupling receiving section as explained above is arranged.

The same features will have the same reference numbers in all figures.

Inside the one piece coupling socket 6 is the plug-in device receiving arrangement. The locking balls 7 can move from a locking position to a non-locking position in slits 8 formed in the coupling socket 6. In a similar manner it is possible for the locking pins 5 to move in angular grooves 9 also provided in the coupling socket.

When the coupling socket is not being activated, the locking balls and the locking pins will, due to the resiliency of the locking ring, be urged into a locking position. When the tip of the plug-in coupling device 14 is correctly and fully inserted into the socket device, see FIG. 4, the front of the tip will push the valve down along an interior cylindrical sliding surface 18 and thereby compress the valve spring 11. During this movement of the valve 10, the valve will leave the gasket or seal 12 and thereby create a free connection for the compressed air or other medium to flow past the valve 10 and into the connected line.

As the valve is pushed forward by the tip of the connecting device, the valve 10 will be guided in its movement by the legs 13 of the valve 10.

1. Rapid coupling device, in particular for use in compressed air lines, wherein the coupling comprises a plug-in and a receiving coupling socket, wherein the coupling socket body is made from one single piece.

2. Rapid coupling device according to claim 1, wherein the coupling socket is adapted to receive a coupling plug-in and the socket comprises
a coupling socket body;
a valve located inside the coupling socket body;
a valve spring urging the valve into a closed position when not coupled to a coupling plug-in;
a gasket/seal between the valve and a valve seat arranged in the coupling socket body;
locking means arranged in the socket for locking a coupling plug-in into secure coupling with the socket;
a locking release means slidingly arranged on the outside of the socket body and influenced by a spring into a locking position.

3. Coupling according to claim 2, wherein the valves travel in an interior cylindrical sliding surface provided in an interior wall of the socket body is less than 10 mm, preferably less than 5 mm.

4. Coupling according to claim 2, wherein the valve is retained in the socket body by an O-ring.

5. Coupling according to claim 1, wherein the valve is made from a resilient material and that the diameter of at least a part of the valve is larger than an interior diameter of the socket body.

6. Coupling socket for use in compressed air lines, wherein the socket comprises locking means for retaining a plug-in device, valve means, connection means to a means for conveying compressed air, wherein the socket body is a single piece.

7. Method for assembling a rapid coupling socket device, wherein all parts are mounted through the coupling opening in the socket body.

8. Method according to claim 7, wherein the assembly is as follows:
a) the valve spring is inserted;
b) the valve is inserted and fitted inside an inner cylindrical sliding surface provided in an interior wall of the socket body and fitted partly inside the valve spring;
c) a first O-ring is arranged in a inner gasket groove;
d) a second O-ring is arranged in an outer gasket groove;
e) a ventilating ring is arranged about the outside of the socket body;
f) a locking spring is arranged about an outside surface of the socket body and in contact with the ventilating ring;
g) a ball ring for retaining locking balls is arranged in contact with the locking spring together with at least two locking balls and, optionally, two locking pins;
h) a ball lock ring and
i) an outer locking ring encapsulating all items arranged on the outside of the socket body.
